(19) United States
(12) Patent Application Publication
(10) Pub. No.: US 2002/0156681 A1
(43) Pub. Date: Oct. 24, 2002

(54) Advertising business method

(76) Inventor: Richard Dark, St. Louis, MO (US)

Correspondence Address: Robert J. Van Der Wall, First Union Financial Center, Suite 5100, 200 South Biscayne Boulevard, Miami, FL, 33131-2310, US

(21) Appl. No.: 10/123,342

(22) Filed: Apr. 16, 2002

Related U.S. Application Data
(60) Provisional application No. 60/285,535, filed on Apr. 23, 2001.

(51) Int. Cl. G06F 17/60

(52) U.S. Cl. 705/14

(57) ABSTRACT

Disclosed is a business method involving removable and replaceable third party paid public advertising using novel advertising sites in locations that are unconventional for advertising previously to generate an unprecedented revenue stream that potentially benefits three parties: (1) the solicitor of the advertising who places said advertising in the unconventional sites, (2) the owner of those sites, and (3) the advertiser who obtains additional business from the unique advertising approach. The method contemplates the following steps: development of the site, furnishing of apparatus to display the advertising, procuring the consent of and signing a contract with each site owner, procuring the advertisers and signing contracts with them, developing with the advertiser the advertising copy, placing the advertising copy at the site, and possibly paying the site owner a portion of the advertising revenue obtained from the advertiser. Sometimes the site owner is not paid, because the apparatus for display of the advertising is itself utilitarian and its placement is compensation enough for the owner.

### CROSS REFERENCE TO OTHER APPLICATIONS

This application claims the benefit of provisional application Serial No. 60/285,535 filed Apr. 23, 2001. This application is copending therewith and claims the filing date thereof as to the common subject matter.

### BACKGROUND OF THE INVENTION

1. Field of the Invention

The invention relates generally to a business method involving public advertising using novel advertising sites referred herein as “noveladsites.” The advertising is removable and replaceable third party paid advertising. Specifically, the invention concerns the method of placement of removable and replaceable third party paid advertising displayed in locations that are unconventional for advertising previously, and involves the establishment of a new business method that generates an unprecedented revenue stream that potentially benefits three parties. The three parties are (1) the solicitor of the advertising who places said advertising in noveladsites, (2) the owner of the noveladsite, and (3) the advertiser who obtains additional business from the unique advertising approach.

The business method contemplates the development of the noveladsite, the furnishing of the apparatus to display the advertising, procuring the consent of and signing a contract with each noveladsite owner, procuring the advertisers and signing contracts with them, developing with the advertiser the advertising copy, placing the advertising copy at the noveladsite, and possibly paying the noveladsite owner a portion of the advertising revenue obtained from the advertiser. Sometimes the noveladsite owner is not paid, because the noveladsite is itself utilitarian and its placement is compensation enough for the owner.

2. Description of the Prior Art

A new trend in the advertising industry has been to develop innovative sites for the placement of revenue producing advertising. In the context of this invention, the term “third party” advertisement contemplates an arms length advertiser that is ordinarily neither the solicitor of the advertising nor the owner of the noveladsite, although neither is precluded.

The closest published technology known to the inventor concerning the placement of removable and replaceable third party paid advertising in unusual sites involve a number of issued U.S. patents relating such advertising in golf holes. Examples are Boudreau, U.S. Pat. No. 4,928,417, Boudreau, et al., U.S. Pat. No. 4,878,665, Dark (the present inventor), U.S. Pat. No. 5,249,384, Hannon, U.S. Pat. No. 5,190,283, Hageman, U.S. Pat. No. 5,362,044, and Mabie, U.S. Pat. No. 5,788,581. The present applicant has also been involved with an unpublished placement of removable and replaceable third party paid advertising in connection with a golf ball mark repair tool and a strap from which the tool is suspended in either of two locations, i.e., the pin (flag pole) that marks the location of the golf hole on the green, or from a roof support on a golf cart. Applicant is also involved presently with placement of such advertising on an injection molded basket attached to the safety bar on a chair ski lift. The basket includes one or more noveladsites for the placement of removable and replaceable third party paid advertising that is displayed before a captive audience. Two further notions are the placement of small liquid crystal screens with programmable graphics aimed at the passengers in taxi cabs and on the inside of the doors to the stalls in public rest rooms.

Bearing in mind the foregoing, it is a principal object of the present invention to provide a business method involving the display of removable and replaceable third party paid advertising in noveladsites.

Another principal object of the present invention is to provide a method that involves the development of noveladsites and the furnishing of apparatus for display of removable and replaceable third party paid advertising.

It is a related principal object of the present invention to provide a method that includes the foregoing in combination with obtaining the consent of and contracting with the owner of the noveladsite.

Another significant object of the invention is procuring the advertisers, assisting in the development of advertising copy, and placing the advertising copy at the noveladsite.

A further object of the invention is possible sharing the revenue from the advertising with the owner of the noveladsite.

The present invention accomplishes the above stated objectives, as well as others, as may be determined by a fair reading and interpretation of the entire specification and claims. Various other objects, advantages, and features of the invention will become apparent to those skilled in the art from the following descriptions taken in conjunction with the appended drawings.

### SUMMARY OF THE INVENTION

In accordance with the principal aspect of the present invention, there is provided a business method which contemplates the development of noveladsites, furnishing of apparatus to display the advertising, procuring the consent of and signing a contract with each noveladsite owner, procuring the advertisers and signing contracts with them, developing with the advertiser the advertising copy, collecting the consideration for the advertising, placing the advertising copy at the noveladsite, and possibly paying the noveladsite owner a portion of the advertising revenue obtained from the advertiser. By way of example and not limitation, samples of noveladsites include on golf ball mark repair tools, on support means for the latter, on baskets attached to the safety bars on ski chair lifts, on programmable liquid crystal displays aimed at the passengers in taxi cabs and on the inside of the doors to the stalls in public rest rooms, and the like.

### BRIEF DESCRIPTION OF THE DRAWINGS

The novel features which are believed to be characteristic of the present inventive method and illustrative implementing apparatus structure, organization, and use, together with further objectives and advantages thereof, will be better understood from the following drawings in which is first shown the steps of the preferred embodiment of the business method, and in which are next shown several examples of noveladsites.

It is expressly understood, however, that the drawings are for the purpose of illustration and description only and are not intended as a definition of the limits of the invention. Embodiments of this invention will now be described by way of example in association with the accompanying drawings in which:

FIG. 1 is block diagram illustrating the steps in the preferred embodiment of the inventive business method.

FIG. 2 is perspective view of a ski chair lift which has been modified by the addition of baskets on the safety bar, and which baskets display removable and replaceable third party paid advertising to a captive audience.

FIG. 3 is a front view of a ball mark repair tool and supporting structure showing multiple noveladsites for the display removable and replaceable third party paid advertising.

FIG. 4 is a side view of just the ball mark tool itself showing it is an essentially planar structure.

FIG. 5 is perspective view of the ball mark repair tool and supporting structure attached to a golf pin on a green.

FIG. 6 is a rear view of a golf cart with the ball mark repair tool and supporting structure attached to a golf cart roof support.

FIG. 7 is a rear view of the front seat in a taxi cab in which is disposed a liquid crystal screen with remotely programmable graphics containing a series of advertisements readily visible to passengers.

FIG. 8 is a perspective view of a public rest room with the door of one stall being open and showing a liquid crystal screen with remotely programmable graphics containing a series of advertisements readily visible to the user of the facility.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for claims hereinafter presented, and as a representative basis for teaching one skilled in the art to variously employ the present invention in virtually any appropriately detailed structure. Reference is now made to the drawings, wherein like characteristics and features of the present invention shown in the various figures are designated by the same reference numerals.

First of all, the inventive business method includes a number of steps which are graphically displayed in FIG. 1. The steps contemplate the development of noveladsites 1, furnishing of apparatus to display the advertising 2, procuring the consent of and signing a contract with each noveladsite owner 3, procuring the advertisers and signing contracts with them 4, developing with the advertiser the advertising copy 5, collecting the consideration for the advertising 6, placing the advertising copy at the noveladsite 7, and possibly paying the noveladsite owner a portion of the advertising revenue obtained from the advertiser 8.

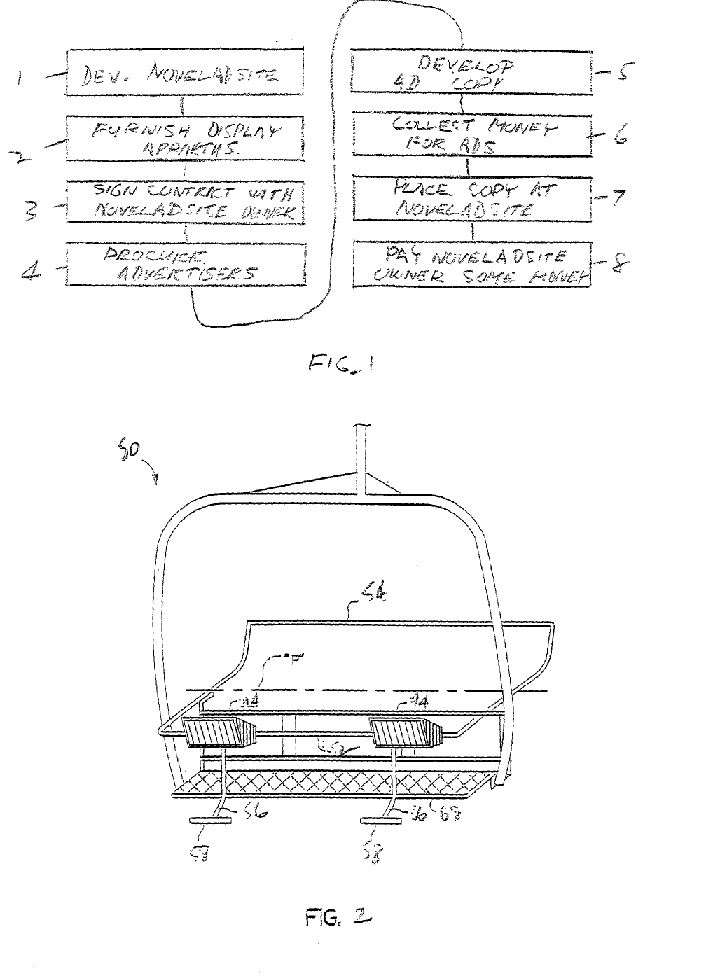

Reference will now be made to FIGS. 2 through 8, which show several noveladsites in which removable and replaceable third party paid advertising is displayed as a focal point of the inventive business method.

FIG. 2 shows ski chair lift 50 with pivoting safety bar 52 fixedly connected to balance bar 54 so that both rotate around horizontal pivoting axis “P”. Safety bar 52 is attached to support bars 56 which in turn are connected to footrests 58. Balance bar 54 tends to counterbalance the safety bar 52, the footrest(s) 58 and the support bars 56. Seat 68 is also seen. Most significantly, removable and replaceable third party paid advertising is disposed on one or more of the panels of the baskets 94 which are fixed to the safety bar 52 and which are noveladsites.

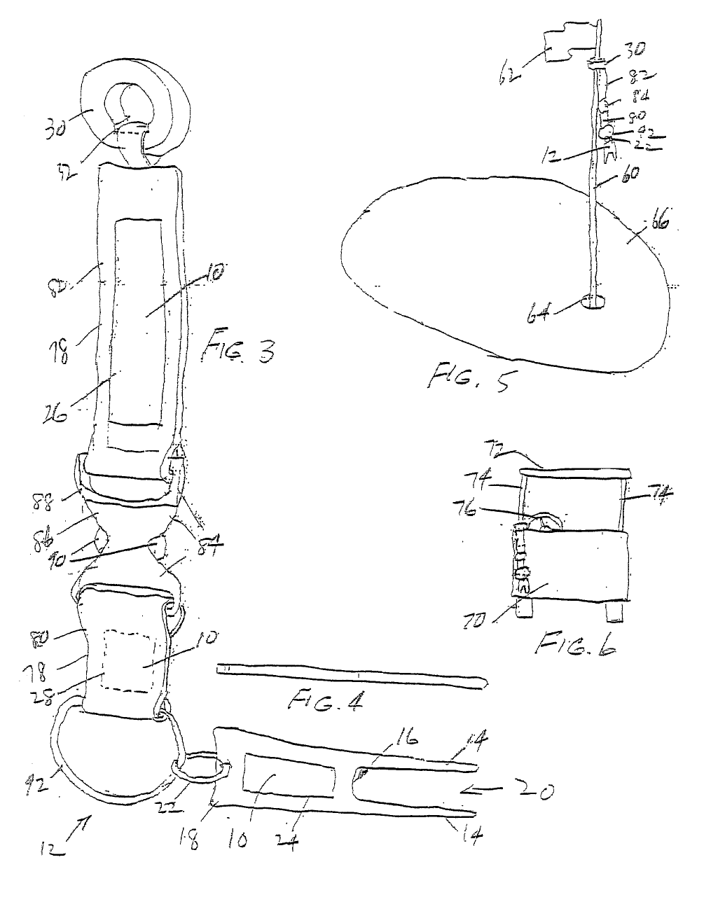

FIG. 3 is a front view of a ball mark repair tool and supporting structure showing multiple noveladsites for the display removable and replaceable third party paid advertising. Specifically disclosed is ball mark repair tool 12 which includes removable and replaceable third party paid advertising 10 at first site 24 disposed on tool head 18. Tool head 18 includes tool aperture 20 in the lower end of ball mark repair tool 12, and further includes ball mark repair tool prongs 14 separated by prong abutment 16.

Ball mark repair tool 12 is removably supported using a ring collar 30 having a ring collar recess 32 to which is connected a two part strap 78 having a strap lower portion 80, strap upper portion 82 removably interconnected by quick release catch 84. Quick release catch 84 is also divided into catch lower portion 86 and catch upper portion 88 which snaps within lower portion 86 and is releasable using catch quick release buttons 90. Strap lower portion 80 terminates in a strap support ring 92 which is attached to connecting ring 22. Strap upper portion 82 provides a second site 26 for removable and replaceable third party paid advertising 10. Strap lower portion 80 contains an alternative third site 28 shown in phantom for removable and replaceable third party paid advertising 10. The entire structure shown in FIG. 1 is supported using ring collar 30 from a conventional pin, or flag pole 60 which is disposed in a golf hole 64 on a golf course green 66. Of course, there is a numbered hole flag 62 supported from pin 60. Ring collar 30 simply slides down pin 60 until the increase in the diameter of pin 60 becomes too great for collar 30 to travel any further down.

FIG. 4 is a side view of just the ball mark tool itself showing it is an essentially planar structure.

FIG. 5 is a perspective view of the ball mark repair tool and supporting structure attached to a golf pin on a green. Specifically, it shows the structure of FIG. 3 including ring collar 30 strap upper portion 82 quick release catch 84 strap lower portion 80 strap support ring 92 connecting ring 22 and ball mark repair tool 12.

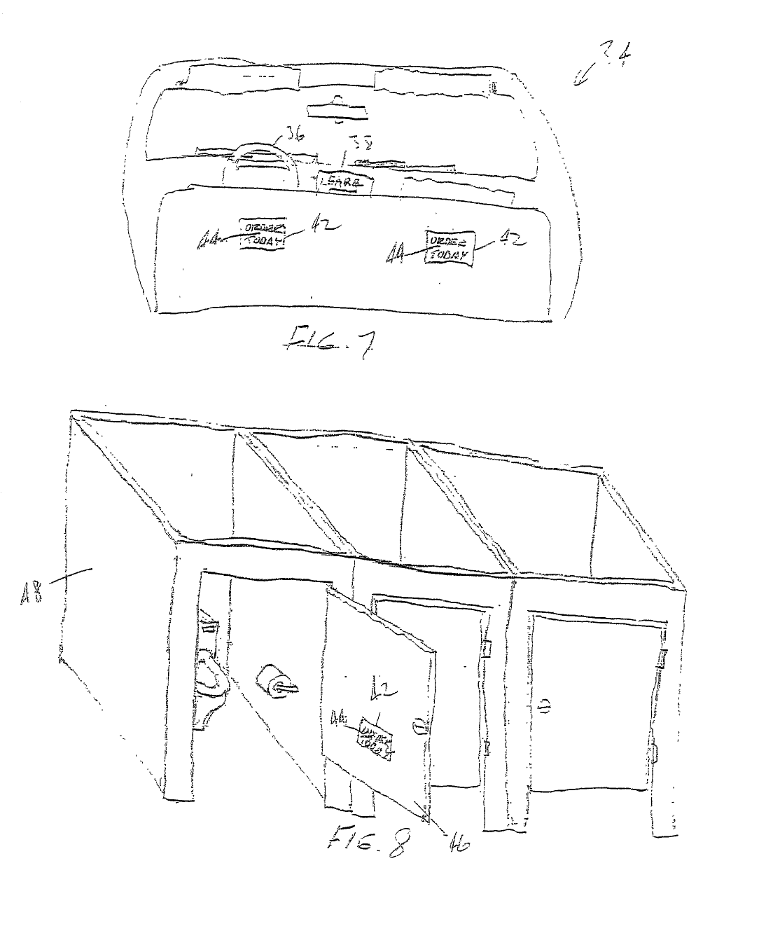

FIG. 6 is a rear view of a golf cart with the ball mark repair tool and supporting structure attached to a cart roof support. Golf cart 70 includes a golf cart roof 72, golf cart steering wheel 76, and golf cart roof supports 74 to which the ball mark repair tool and supporting structure seen in FIGS. 3 and 4 is attached.

FIG. 7 is a rear view of the front seat in a taxi cab in which is disposed a liquid crystal screen with remotely programmable graphics containing a series of advertisements readily visible to passengers. Specifically, the inside of taxi cab 34 discloses steering wheel 36, fare meter 38 and front seat 40. Disposed in a flush configuration with the back of front seat 40 rare liquid crystal screens 42 on which is displayed constantly changing indicia 44 which are the advertisements.

FIG. 8 is a perspective view of a public rest room with the door 46 of one stall 48 being open and showing a liquid crystal screen 42 with remotely programmable graphics 44 containing a series of advertisements readily visible to the user of the facility.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims appended hereto.

What is claimed is:

1. A third party paid replaceable advertising business method comprising:
developing a noveladsite;
procuring advertising from an advertiser;
applying the advertising to the noveladsite; and
receiving consideration for the advertising.

2. The business method of claim 1 in which developing a noveladsite further comprises:
furnishing of apparatus to display the advertising; and
disposing the apparatus at the noveladsite.

3. The business method of claim 1 in which developing a noveladsite further comprises procuring consent of each noveladsite owner to display advertising at each noveladsite.

4. The business method of claim 3 in which developing a noveladsite further comprises signing a contract with each noveladsite owner documenting the consent to display advertising.

5. The business method of claim 1 in which procuring advertising from an advertiser further comprises signing an advertising contract with the advertiser.

6. The business method of claim 1 in which procuring advertising from an advertiser further comprises developing advertising copy with the advertiser.

7. The business method of claim 2 in which applying the advertising to the noveladsite further comprises:
disposing the advertising copy at the apparatus; and
attaching the advertising copy to the apparatus.

8. The business method of claim 1 which further comprises paying the noveladsite owner a portion of the consideration obtained from the advertiser.

9. The business method of claim 1 in which developing a noveladsite further comprises:
furnishing of utilitarian apparatus to display the advertising, wherein the utilitarian apparatus serves as consideration to a noveladsite owner for consenting to display of advertising at the noveladsite; and
disposing the apparatus at the noveladsite.

10. A third party paid replaceable advertising business method comprising:
developing a noveladsite;
furnishing apparatus to display advertising;
procuring consent from each noveladsite owner for displaying advertising at each noveladsite;
procuring an advertiser; and
placing advertising copy at the noveladsite.

11. The business method of claim 10 in which procuring consent from each noveladsite owner for displaying advertising at each noveladsite further comprises signing a contract with each noveladsite owner.

12. The business method of claim 10 in which procuring the advertiser further comprises signing a contract with the advertiser.

13. The business method of claim 10 in which procuring the advertiser further comprises developing advertising copy with the advertiser.

14. The business method of claim 10 which further comprises paying the noveladsite owner a portion of advertising revenue obtained from the advertiser.

15. The business method of claim 10 in which the apparatus furnished to display advertising is utilitarian in nature and its placement is compensation enough for the noveladsite owner to consent to placement of advertising.

16. A third party paid replaceable advertising business method comprising:
developing a noveladsite including procuring consent from each noveladsite owner for displaying advertising at each noveladsite and signing a contract with each noveladsite owner;
furnishing apparatus to display advertising;
procuring an advertiser including signing a contract with the advertiser and developing advertising copy with the advertiser; and
placing advertising copy at the noveladsite.

17. The business method of claim 17 which further comprises paying the noveladsite owner a portion of advertising revenue obtained from the advertiser.

18. The business method of claim 16 in which the apparatus furnished to display advertising is utilitarian in nature and its placement is compensation enough for the noveladsite owner to consent to placement of advertising.
